(19) United States
(12) Patent Application Publication
(10) Pub. No.: US 2026/0087231 A1
(43) Pub. Date: Mar. 26, 2026

(54) ENHANCED DIGITAL INK HANDWRITING REFLOW

(71) Applicants: Chun Yu KOK, Hong Kong (CN); Wui Ki Calvin CHENG, Hong Kong (CN); Kwan Yau Leo LAU, Hong Kong (CN); Ka Sing NG, Hong Kong (CN)

(72) Inventors: Chun Yu KOK, Hong Kong (CN); Wui Ki Calvin CHENG, Hong Kong (CN); Kwan Yau Leo LAU, Hong Kong (CN); Ka Sing NG, Hong Kong (CN)

(21) Appl. No.: 19/332,978

(22) Filed: Sep. 18, 2025

(30) Foreign Application Priority Data
Sep. 23, 2024 (WO) PCT/CN2024/120434

(51) Int. Cl. G06F 40/106; G06F 40/171; G06V 30/148; G06V 30/22; G06V 30/32

(52) U.S. Cl. CPC G06F 40/106; G06F 40/171; G06V 30/153; G06V 30/22; G06V 30/347

(57) ABSTRACT

This disclosure describes systems, methods, and devices for reflow of digitally entered handwritten characters into a device. A method may include receiving handwritten strokes digitally entered into a text container presented using a device; generating groups of the handwritten strokes into text lines and words along the text lines; determining, using a baseline estimation algorithm, a respective baseline for each of the text lines; identifying, for each respective baseline, a lowest x-coordinate of the handwritten strokes; determining, for each of the words, a distance between a respective word on a respective baseline and a consecutive word on the respective baseline; determining, based on a width of the text container, the respective baselines, and the distance, a placement of each of the words in the text container; and causing presentation, using the device, of the words in the text container based on the placement.

### CROSS-REFERENCE TO RELATED APPLICATION(S)

This application claims the benefit of PCT Provisional Application No. PCT/CN2024/120434, filed Sep. 23, 2024, the disclosure of which is incorporated herein by reference as if set forth in full.

### TECHNICAL FIELD

Embodiments of the present invention generally relate to systems and methods for organizing digital handwriting written on a computer device.

### BACKGROUND

Devices may allow users to handwrite text rather than enter text using keystrokes. Users who digitally handwrite text onto a device may need to adjust the layout of their digital handwriting.

### BRIEF DESCRIPTION OF THE DRAWINGS

FIG. 1 illustrates an example process for line and word segmentation of handwritten text into a device for handwriting reflow, in accordance with one embodiment.

FIG. 2 illustrates an example of the word segmentation of FIG. 1, in accordance with one embodiment.

FIG. 3 illustrates an example text container for the handwritten text of FIG. 1, in accordance with one embodiment.

FIG. 4 illustrates an example adding of words from the handwritten text of FIG. 1 to a new line in the text container of FIG. 3, in accordance with one embodiment.

FIG. 5 is an example schematic diagram of one or more artificial intelligence models that may be used for reflow of text that is handwritten into a computer device, in accordance with one embodiment.

FIG. 6 is an example system for reflow of digitally entered handwritten characters into a device, in accordance with one embodiment.

FIG. 7 is a flow for an example process for reflow of digitally entered handwritten characters into a device, in accordance with one embodiment.

FIG. 8 is a diagram illustrating an example of a computing system that may be used in implementing embodiments of the present disclosure.

FIG. 9 illustrates an example neural network, in accordance with one embodiment.

Certain implementations will now be described more fully below with reference to the accompanying drawings, in which various implementations and/or aspects are shown. However, various aspects may be implemented in many different forms and should not be construed as limited to the implementations set forth herein; rather, these implementations are provided so that this disclosure will be thorough and complete, and will fully convey the scope of the disclosure to those skilled in the art. Like numbers in the figures refer to like elements throughout. Hence, if a feature is used across several drawings, the number used to identify the feature in the drawing where the feature first appeared will be used in later drawings.

### DETAILED DESCRIPTION

Aspects of the present disclosure involve systems, methods, and the like, for enhanced reflow of digital handwriting written on a computer device.

Devices may allow users to input characters in a variety of ways, such as with keystrokes and stylus strokes. When a user enters a keystroke (e.g., using a keyboard), the keystroke is converted to a corresponding character, such as a letter, number, symbol, or punctuation mark. When a key is pressed on a keyboard, it is converted into a binary number that represents a character, so there is no ambiguity in determining which character a user typed with a keystroke. In contrast, when a user handwrites text into a computer device with an electronic device or a user's finger, such as with a stylus or their finger, many variations in the handwriting introduce ambiguity when determining what characters the handwriting represents. Analyzing characters handwritten into a device, therefore, depends on the ability of the computer device to correctly identify the characters represented by the handwriting.

Humans may identify and categorize handwritten characters after seeing only a few examples, but a machine's ability to identify and categorize handwritten characters may require significantly more examples to train. An electronic device encompasses a broad array of electronic gadgets, including tools such as a digital stylus or any comparable apparatus, which permit the user to sketch characters on a computer interface as a form of hand-drawn or handwritten input. Beyond the use of an electronic device for inputting strokes onto the computer device, users can also engage the intuitiveness of their own fingers as a dynamic and natural means to accomplish the same task, thus providing a more direct and tactile interaction with the digital interface. Throughout this disclosure, while electronic devices are primarily illustrated as examples, it should be understood that the scope of interaction is not limited to these alone. A user's finger also serves as a viable tool for interacting with computer devices. Hence, the exemplification of an electronic device should not be misconstrued as a limitation, but rather, it serves as one among many possible methods for interaction in the broader digital landscape. A computer device, such as a laptop, tablet, or smartphone, can be described as a sophisticated system equipped with an interactive interface designed to accept and interpret strokes from an electronic device, recording these inputs as lines, characters, shapes, and more. This interaction transforms abstract human action into digitized elements.

To allow a computer device to analyze characters handwritten into the computer device, correctly identifying the handwritten text is important to a computer device's ability to assess the words represented by the handwritten text. If the computer device improperly identifies handwritten characters, then the computer device may not correctly be able to perform reflow to reorganize the layout of the characters.

Text reflow refers to the process of dynamically adjusting the layout of text within electronic documents to fit an available space, such as when a user changes the width of a text container into which a user may digitally handwrite characters on a computer device. This is a capability for typed text in text editing or viewing applications. Text reflow may include a variety of typographical modifications, such as changing a font size, font, or thickness, and/or changes to the dimensions of a text container, which may cause words written on one line to change to another line.

However, in free-form digital note-taking, reflowing handwriting (e.g., digital ink) has to be performed manually, and the manual process is cumbersome and different than how a computer would automatically perform reflow. For example, to fit a handwritten paragraph into an area with a different width, the user would have to carefully position different pieces of text into the area, making sure that the baselines of the text are aligned and the spacing is consistent.

Enabling automatic reflowing for digital handwriting would allow users to edit and format their handwriting more easily. They could resize or reformat the text without having to manually adjust each line, making it much simpler to organize and present information.

The baseline of handwriting is defined as the line upon which characters rest. In one or more embodiments, a multi-step approach is applied. The first step is for a device to process the digital handwriting to extract the baseline of each text line and split the text into words. The second step is to “greedily” (e.g., using a greedy algorithm) pack the words into the target area given a fixed maximum line length.

In one or more embodiments, for the device to process the digital handwriting to extract the baseline of each text line and split the text into words, the device may apply a grouping model to group the handwritten strokes into words and lines so that for each stroke, the device may identify which word to which the stroke belongs, and for each word, the device may identify to which line it belongs. For example, the device may use a line segmentation model to group the strokes into text lines, and then may apply a word segmentation model to split the text lines into words. The lines may be ordered vertically (e.g., top to bottom), and words may be ordered horizontally (e.g., left to right). For each text line (line), the device may calculate line.baseline using a baseline estimation algorithm, and may record line.x_start, the lowest x-coordinate across the stroke points (e.g., where the line begins on the device display). For each word (word), the device may calculate and record word.next_space, the distance between itself and the next word along the baseline. The recorded information for the first step is summarized below in Table 1.

TABLE 1
Recorded Information in the First Step of Line and Word Segmentation

| | Description | Obtained using |
|---|---|---|
| lines | An array of text lines. lines[i] denotes | Stroke grouping model |
| | the i-th text line. | |
| line.baseline | The baseline of the text line. | Baseline estimation algorithm |
| line.x_start | The beginning of the text line. | Smallest x-coordinate |
| line.words | An array of words in the text line. | Stroke grouping model |
| | line.words[j] denotes the j-th word in | |
| | that line. | |
| word.next_space | The width of the space following the | Distance between itself and the |
| | word. | next word along the baseline. |

In one or more embodiments, to pack the words into the text container, the device may pack the words into the text lines sequentially, given the width of the text container, following the original line and word order of the text. The device may initialize an empty text line with a baseline and starting location. Depending on the application, this could be a flat baseline with the left border of the text container as the starting location, or the baseline and starting location of the first line from the original text block (e.g., lines[0].baseilne and lines[0].x_start). The device may add the words sequentially to the text container. A word may be appended to a current line when there is sufficient space, otherwise a new line may be created, and to which the word may be added.

In one or more embodiments, a computer device may receive handwritten strokes on a screen or touchpad, such as with a stylus or a user's finger, representing handwritten characters. The device may analyze the handwritten strokes to identify the characters represented by the handwritten strokes based on the X and Y coordinates of the strokes on the computer device. The computer device may recognize math represented by the characters, strip units from the math (e.g., X apples and Y oranges as handwritten inputs may be stripped to X and Y without the units-apples and oranges).

A computer device-based analysis of handwritten characters also must be able to process the characters identified from the handwritten inputs to the computer device. The list of supported languages for handwriting recognition and question and answer analyses includes but is not limited to English, German, French, Spanish, Portuguese, Italian, Dutch, Chinese, Japanese, Korean, Thai, Russian, and Turkish. The list of supported languages includes but is not limited to English, German, French, Spanish, Portuguese, Italian, Dutch, Thai, Russian and Turkish.

The above descriptions are for the purpose of illustration and are not meant to be limiting. Numerous other examples, configurations, processes, etc., may exist, some of which are described in greater detail below. Example embodiments will now be described with reference to the accompanying figures.

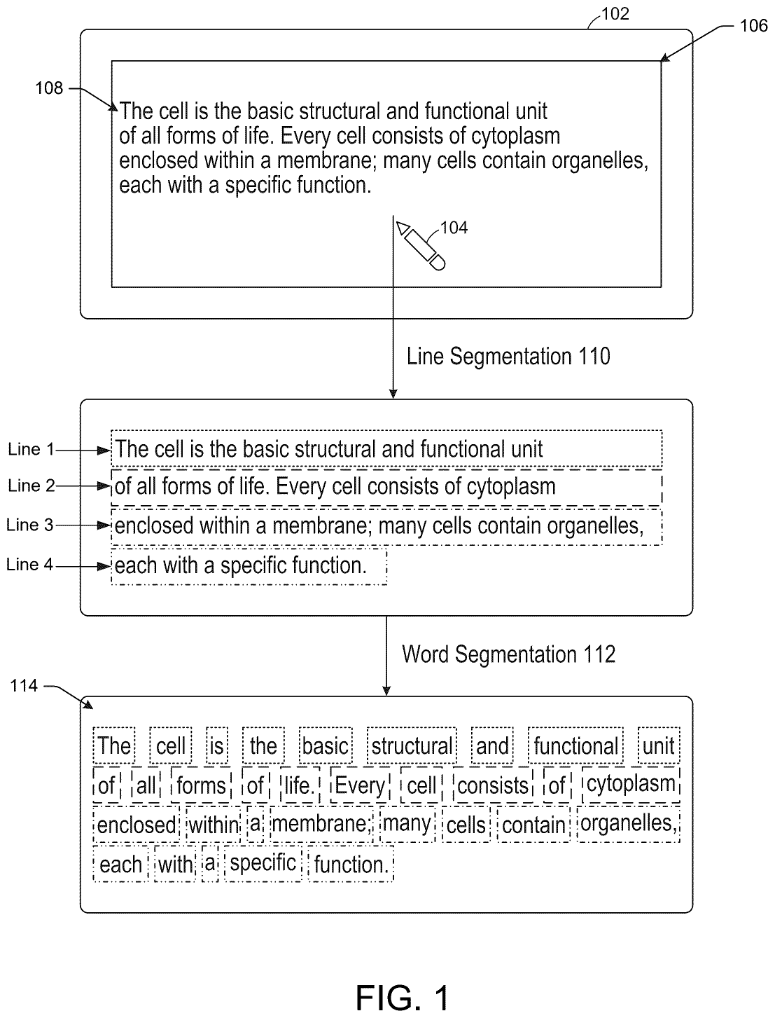

FIG. 1 illustrates an example process for line and word segmentation of handwritten text into a device for handwriting reflow, in accordance with one embodiment.

Referring to FIG. 1, a user may handwrite characters into a computer device 102 using a handwriting tool 104 (e.g., stylus, finger, or the like). The space into which the characters may be digitally handwritten may be referred to as a text container 106. The baseline of the handwriting is defined as the line upon which characters rest. In one or more embodiments, a multi-step approach is applied to segment the text 108 (e.g., represented by the handwritten characters) by lines (e.g., line segmentation 110) and by words (e.g., word segmentation 112). The first step is for the computer device to process the digital handwriting to extract the baseline of each text line (e.g., line 1, line 2, line 3, line 4, etc.) and then split the text into words 114. The second step is to “greedily” (e.g., using a greedy algorithm) pack the words 114 into the target area given a fixed maximum line length.

In one or more embodiments, for the computer device 102 (or another device remote from the computer device 102) to process the digital handwriting to extract the baseline of each text line and split the text into words 114, the computer device 102 may apply a grouping model to group the handwritten strokes into words and lines so that for each stroke, the computer device 102 may identify which word to which the stroke belongs, and for each word, the computer device 102 may identify to which line it belongs.

For the line segmentation 110, the computer device 102 may use a line segmentation model to group the strokes into text lines. For example, “The cell is the basic structural and functional unit” is one line, “of all forms of life. Every cell consists of cytoplasm” is another line, “enclosed within a membrane; many cells contain organells” is another line, and “each with a specific function” is another line. As shown, lines are not identified based on full sentences or punctuation, as a sentence may span multiple lines.

For the word segmentation 112, the computer device 102 may apply a word segmentation model to split the text lines into words 114. Using a stroke grouping model, the computer device 102 may identify line.words[j] denoting the j-th word in that line. Then the computer device 102 may identify the width of the space following a respective word (e.g., the distance between the j-th word and the j+1-th word).

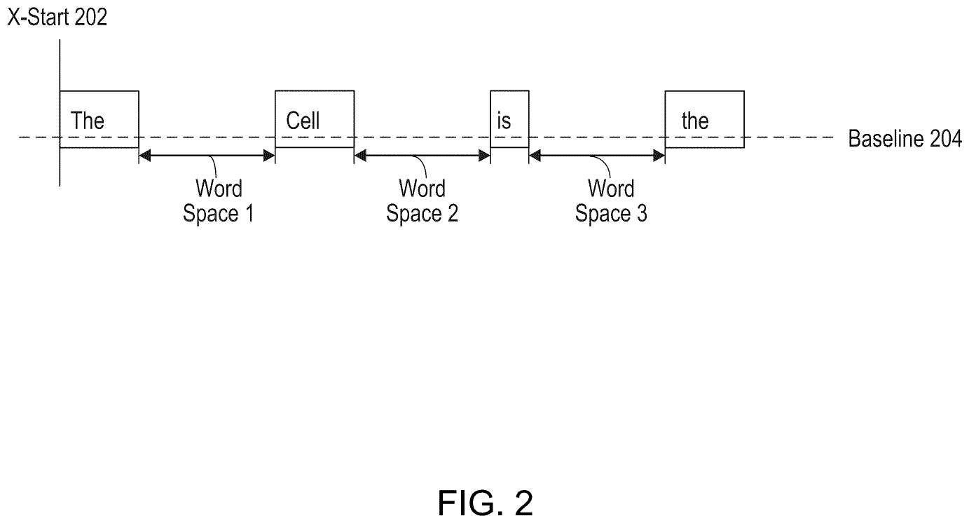

The lines may be ordered vertically (e.g., top to bottom), and words may be ordered horizontally (e.g., left to right). As shown further with respect to FIG. 2, for each text line (line), the computer device 102 may calculate line.baseline using a baseline estimation algorithm, and may record line.x_start, the lowest x-coordinate across the stroke points (e.g., where the line begins on the device display, corresponding to the “T” in the “The cell”). For each word 114 (word), the computer device may calculate and record word.next_space, the distance between itself and the next word along the baseline.

In one or more embodiments, to pack the words 114 into the text container 106, the computer device 102 may pack the words into the text lines sequentially, given the width of the text container, following the original line and word order of the text. The computer device 102 may initialize an empty text line with a baseline and starting location. Depending on the application, this could be a flat baseline with the left border of the text container as the starting location, or the baseline and starting location of the first line from the original text block (e.g., lines[0].baseilne and lines [0].x_start). The computer device 102 may add the words 114 sequentially to the text container 106. A word may be appended to a current line when there is sufficient space, otherwise a new line may be created, and to which the word may be added.

FIG. 2 illustrates an example of the word segmentation 112 of FIG. 1, in accordance with one embodiment.

Referring to FIG. 2, the x-start position 202 of the handwritten text 108 in FIG. 1 is identified as the lowest x-coordinate across the stroke points, corresponding to the “T” in the “The cell” in the text 108. The word “The” is identified, a word space 1 between the word “The” and the word “cell” is identified, a word space 2 between the word “cell” and the word “is” is identified, and a word space 3 between the word “is” and the word “the” is identified along the baseline. In this manner, beginning with the lowest x-coordinate of the top line across the stroke points, the individual words 118 may be identified as the x-coordinate increases along the baseline 204.

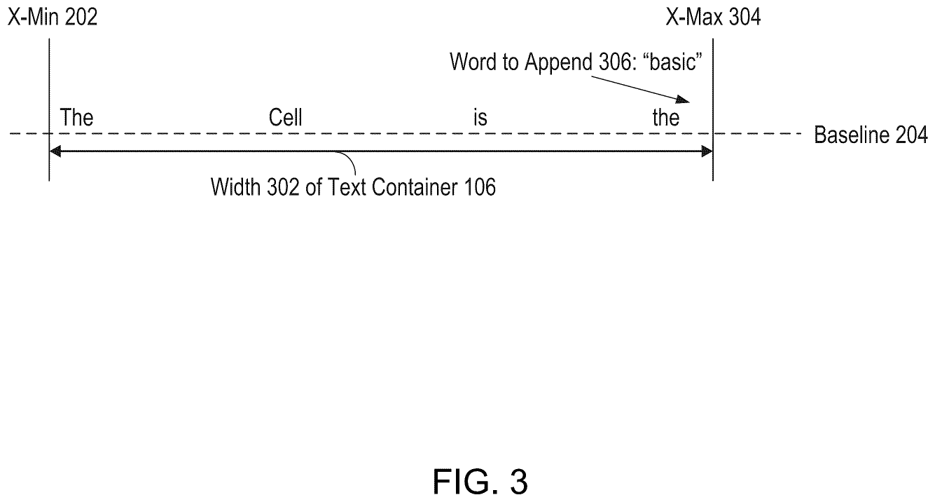

FIG. 3 illustrates an example text container for the handwritten text 108 of FIG. 1, in accordance with one embodiment.

Referring to FIG. 3, the width 302 of a text container is the distance from x-min (x-start 202) to x-max 304 (e.g., the largest x-coordinate of the strokes along the baseline 204). When there is sufficient space to add a word 306 to a text container 106 (e.g., based on length of the word 306 being appended and the distance from the word 306 with the greatest x-coordinate along the baseline to the x-max 304 coordinate), the computer device 102 may add the word 306 to the text container 106 on the same line (along the baseline 204).

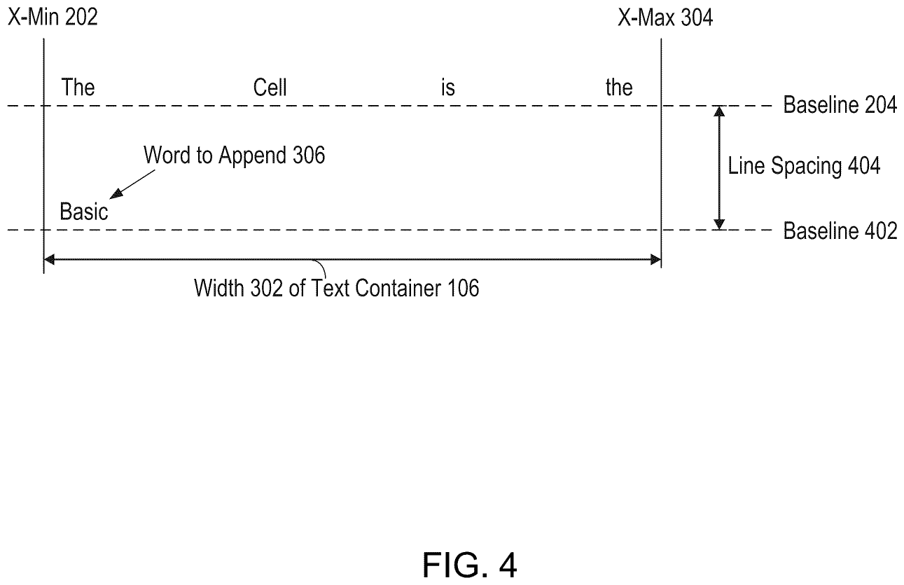

In one or more embodiments, to pack the words 118 into the text container 106, the computer device 102 may pack the words 118 into the text lines sequentially, given the width 302 of the text container 106, following the original line and word order of the text 108. The computer device 102 may initialize an empty text line with a baseline 204 and starting location (x-min 202). Depending on the application, this could be a flat baseline with the left border of the text container as the starting location, or the baseline and starting location of the first line from the original text block (e.g., lines[0].baseilne and lines[0].x_start). The computer device 102 may add the words 118 sequentially to the text container 106. A word may be appended to a current line when there is sufficient space, otherwise a new line may be created (as shown in FIG. 4), and to which the word may be added.

FIG. 4 illustrates an example adding of words from the handwritten text 108 of FIG. 1 to a new line in the text container of FIG. 3, in accordance with one embodiment.

Referring to FIG. 4, when a word 306 is too long to fit within a text container 106 (e.g., its largest x-coordinate when appended next to a word on a same line is greater than x-max 304), the word 306 may be added to a subsequent baseline 402 (e.g., vertically below the previous line) with a line spacing 404 in between the baseline 402 and the baseline 204. As shown in FIG. 4, when the word “basic” will not fit between the word “the” and x-max 304 on a first line, the word “basic” may be appended to a second line (e.g., using baseline 402), beginning at x-min 202.

In this manner, for a text container of any size, even when the text container size is set or resized by a user, the computer device 102 may detect the left-most and right-most boundaries of the text container 106. Starting from the left-most boundary of the text container, the computer device 102 may append words sequentially to a baseline based on line.baseline, line.x_start, line.words[j], and word.next_space as long as the j-th word being added to a baseline fits within the right-most boundary of the text container 106 given the right-most x-coordinate of the preceding word on the baseline, the distance between the two words, and right-most x-coordinate of the next word with respect to the right-most boundary of the baseline.

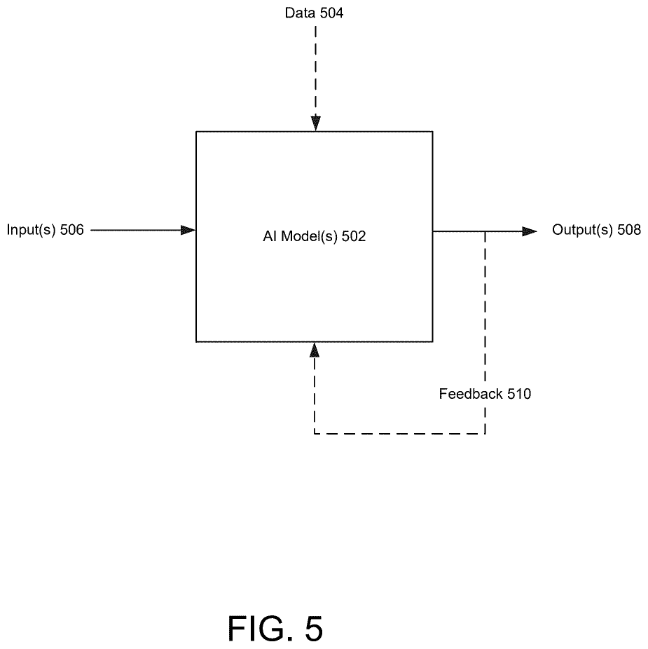

FIG. 5 is an example schematic diagram of one or more artificial intelligence models that may be used for reflow of text that is handwritten into a computer device, in accordance with one embodiment.

Referring to FIG. 5, one or more artificial intelligence (AI) models 502 (or machine learning models) may be used for any of detecting the handwritten characters, determining that the handwritten characters represent characters, identifying lines of characters, identifying words of characters, identifying the elements of Table 1 above, and facilitating text reflow operations. The one or more AI models 502 may receive inputs, optionally may receive data 504 (e.g., training data, one- or few-shot examples, user feedback, etc.), and may generate outputs 508. Optionally, feedback 510 from the outputs 508 may be input into the one or more AI models 502, such as human-in-the-loop feedback, user feedback, comparisons of the outputs 508 to known outputs and their differences (e.g., used to adjust the one or more AI models 502, such as by adjusting weights for identifying characters, text lines, words, etc.).

In one or more embodiments, the text identification of handwritten characters may use few-shot learning, one-shot learning, or no-shot learning. In few-shot learning, computer vision and/or natural language processing may be used to recognize, parse, and classify handwritten characters. In one-shot learning, images of handwritten text may be used to identify similarities on the example images and the handwritten text inputs. In zero-shot learning, a machine learning model may not need to be trained, but instead learns the ability to predict handwritten characters.

In one or more embodiments, when the one or more AI models 502 are used to detect handwritten characters, the inputs 506 may be the handwritten strokes and/or characteristics of the handwritten strokes, such as their pixel coordinates on the display with which they were input. The data 504 may include features of characters, such as their coordinates, shapes, sizes, and the like, accounting for different fonts, such as cursive, block letters, etc. The outputs 508 may include the characters identified from the handwritten strokes. The outputs 508 may be re-input to the one or more AI models 502 until the one or more AI models 502 determine that the confidence score assigned to the identified characters exceeds a threshold confidence. The closer the similarities between the inputs 506 and the known characters, for example, the higher the confidence score for identifying the characters.

In one or more embodiments, when the one or more AI models 502 are used for a language model, the inputs 506 may include sanitized and normalized text data converted into a textual representation. The data 504 may include text with various semantic structures. The outputs 508 may include identified text lines and words. The data 504 also may include clusters of similar hand strokes and clusters of text with similar content so that the outputs 508 may include the hand stroke clusters and the text clusters.

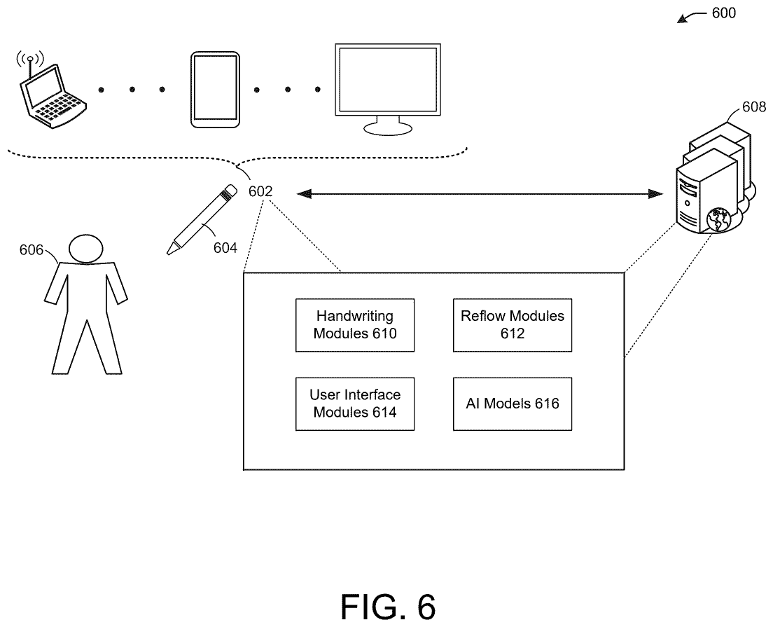

FIG. 6 is an example system 600 for reflow of digitally entered handwritten characters into a device, in accordance with one embodiment.

Referring to FIG. 6, the system 600 may include one or more devices 602 (e.g., laptops, desktops, smartphones, smart home assistants, wearable devices, televisions, or the like) capable of displaying text and receiving handwritten strokes (e.g., from a stylus 604, a finger of a user 606, or another input device). The system 600 may include one or more remote devices 608 (e.g., servers, cloud-based devices, etc.). The one or more devices 602 and/or the one or more remote devices 608 may execute applications that receive, analyze, and correct handwritten strokes input via the one or more devices 602. For example, the one or more devices 602 may transmit indications of the handwritten strokes and/or any analysis of the handwritten strokes to the one or more remote devices 608 (e.g., a front-end/back-end integration of the application). Alternatively, the one or more devices 602 may analyze, detect lines and words of handwritten strokes, and perform text reflow operations locally.

Still referring to FIG. 6, the one or more devices 602 and/or the one or more remote devices 608 may include handwriting modules 610 (e.g., for receiving and detecting handwritten strokes, identifying the characters of the handwritten strokes), reflow modules 612 (e.g., for detecting lines and words from handwritten strokes and placing the words in text containers based on reflow operations), one or more user interface modules 614 (e.g., for generating the presentable data of the user interfaces shown in the figures, including the handwritten strokes and text containers), and AI models 616 (e.g., the one or more AI models 502 of FIG. 5).

In one or more embodiments, the one or more devices 602 may receive handwritten strokes on a screen or touchpad, such as with the stylus 604 or a user's finger, representing handwritten characters. The handwriting modules 610 may analyze the handwritten strokes to identify the characters represented by the handwritten strokes based on the X and Y coordinates of the strokes on the one or more devices 602. The handwriting modules 610 and/or the reflow modules 612 may group handwritten strokes into lines of text and into words. In this manner, the enhanced techniques herein differ from the way that a human operator would analyze and reflow handwritten text based on container size adjustment and/or text font/size adjustment.

In one or more embodiments, the one or more devices 602 and/or the one or more remote devices 608 may use machine learning (e.g., the AI models 616) for one or multiple aspects of the reflow operations. For example, a machine learning model may be used to assess the handwritten strokes as inputs, and identify the characters represented by the strokes based on features of the strokes, such as the X and Y coordinates of the strokes on the device.

It is understood that the above descriptions are for purposes of illustration and are not meant to be limiting.

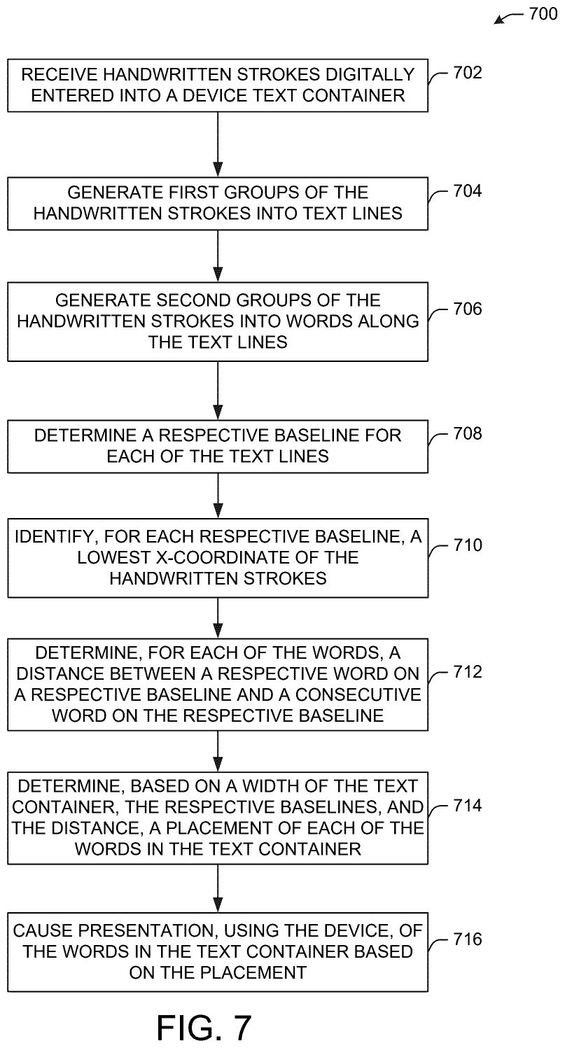

FIG. 7 is a flow for an example process 700 for reflow of digitally entered handwritten characters into a device, in accordance with one embodiment.

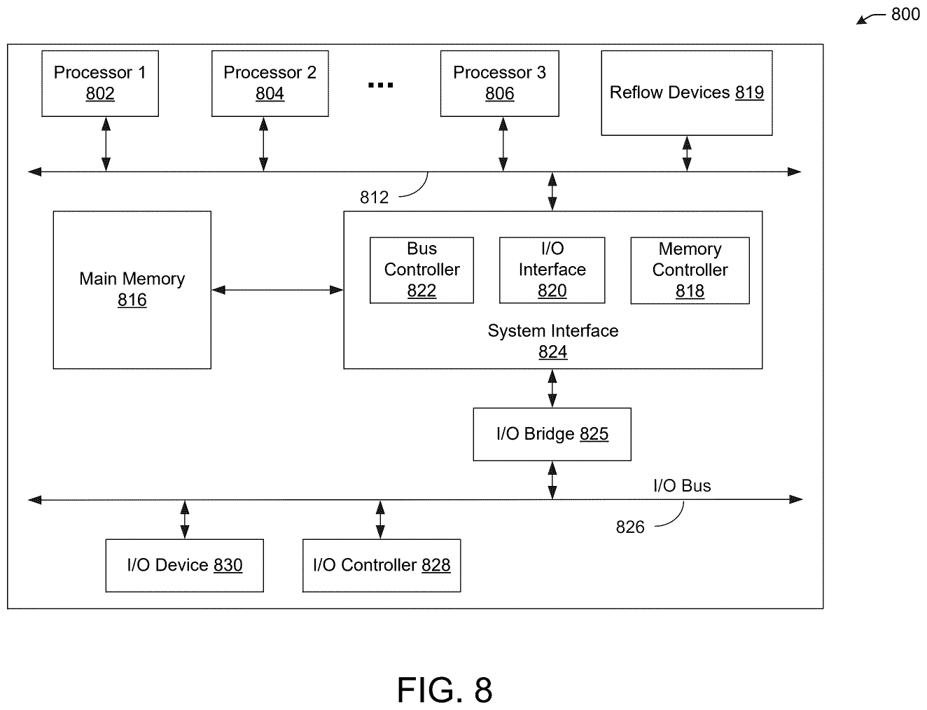

At block 702, a device (or system, e.g., the one or more devices 602 of FIG. 6, the reflow modules 612 of FIG. 6, and/or the reflow devices 819 of FIG. 8) may receive handwritten strokes digitally entered into a text container of a device (e.g., as shown in FIG. 1).

At block 704, the device may generate first groups of the handwritten strokes into text lines, such as by using a line segmentation model. The model may use a convolutional network, a deep learning network (e.g., with a convolutional network, U-network, or the like), or another model.

At block 706, the device may generate second groups of the handwritten strokes into words along the text lines, such as by using a word segmentation model. The model may be a rule-based model, a supervised or unsupervised model, a classification model, or the like.

At block 708, the device may determine a respective baseline for each of the text lines. The words may be placed along the respective baselines of the text lines based on their lengths and the widths of the text container.

At block 710, the device may identify, for each respective baseline, a lowest x-coordinate of the handwritten strokes. The words may be placed in the text container based on distances measured from the lowest x-coordinate of a respective baseline or the overall width of the text container.

At block 712, the device may determine, for each of the words, a distance between a respective word on a respective baseline and a consecutive (e.g., next subsequent word) on the same baseline.

At block 714, the device may determine, based on the width of the text container, the respective baselines, and the distances between words, a placement of each of the words in the text container. Based on the amount of space between a right-most word on a baseline and the right-most boundary of the text container, the device may determine whether the next word would fit between the right-most word and the right-most boundary of the text container. Because the device has identified the words and the distances between the words, the device may determine whether the length of the next word fits in the space that follows the distance between the right-most word and the next word. If so, the next word may be placed on the same line. If not, a next line may be generated, and the next word may become the left-most word on the next line.

At block 716, the device may cause presentation of the words in the text container, based on the dimensions of the text container and the placements. In this manner, as a text container is resized or the text is resized or its font is modified, the reflow operation may place words based on their fit within the text container, and the text container with the word placements may be presented. The presentation may happen in real-time as a reflow occurs so that a user may see how the text is reorganized within the text container even as the text container is resized (e.g., with a user input).

The examples herein are not meant to be limiting.

FIG. 8 is a diagram illustrating an example of a computing system 800 that may be used in implementing embodiments of the present disclosure.

FIG. 8 is a block diagram illustrating an example of a computing device or computer system 800, which may be used in implementing the embodiments of the components disclosed above. For example, the computing system 800 of FIG. 8 may represent at least a portion of the one or more devices 402, and/or the one or more remote devices 414 of FIG. 4, as discussed above, capable of performing any of the processes of FIGS. 1-4 and 7, and capable of facilitating the AI of FIG. 5. The computer system (system) includes one or more processors 802-806. Processors 802-806 may include one or more internal levels of cache (not shown) and a bus controller 822 or bus interface unit to direct interaction with the processor bus 812. Processor bus 812, also known as the host bus or the front side bus, may be used to couple the processors 802-806 with the system interface 824. System interface 824 may be connected to the processor bus 812 to interface other components of the system 800 with the processor bus 812. For example, system interface 824 may include a memory controller 818 for interfacing a main memory 816 with the processor bus 812. The main memory 816 typically includes one or more memory cards and a control circuit (not shown). System interface 824 may also include an input/output (I/O) interface 820 to interface one or more I/O bridges 825 or I/O devices with the processor bus 812. One or more I/O controllers and/or I/O devices may be connected with the I/O bus 826, such as I/O controller 828 and I/O device 830, as illustrated. The system 800 may include one or more reflow devices 819 (e.g., representing at least a portion of the modules of FIG. 4, and capable of performing any of the processes of FIGS. 1-4 and 7, and capable of facilitating the AI of FIG. 5).

I/O device 830 may also include an input device (not shown), such as an alphanumeric input device, including alphanumeric and other keys for communicating information and/or command selections to the processors 802-806. Another type of user input device includes cursor control, such as a mouse, a trackball, or cursor direction keys for communicating direction information and command selections to the processors 802-806 and for controlling cursor movement on the display device.

System 800 may include a dynamic storage device, referred to as main memory 816, or a random access memory (RAM) or other computer-readable devices coupled to the processor bus 812 for storing information and instructions to be executed by the processors 802-806. Main memory 816 also may be used for storing temporary variables or other intermediate information during execution of instructions by the processors 802-806. System 800 may include a read only memory (ROM) and/or other static storage device coupled to the processor bus 812 for storing static information and instructions for the processors 802-806. The system outlined in FIG. 8 is but one possible example of a computer system that may employ or be configured in accordance with aspects of the present disclosure.

According to one embodiment, the above techniques may be performed by computer system 800 in response to processor 804 executing one or more sequences of one or more instructions contained in main memory 816. These instructions may be read into main memory 816 from another machine-readable medium, such as a storage device. Execution of the sequences of instructions contained in main memory 816 may cause processors 802-806 to perform the process steps described herein. In alternative embodiments, circuitry may be used in place of or in combination with the software instructions. Thus, embodiments of the present disclosure may include both hardware and software components.

A machine readable medium includes any mechanism for storing or transmitting information in a form (e.g., software, processing application) readable by a machine (e.g., a computer). Such media may take the form of, but is not limited to, non-volatile media and volatile media and may include removable data storage media, non-removable data storage media, and/or external storage devices made available via a wired or wireless network architecture with such computer program products, including one or more database management products, web server products, application server products, and/or other additional software components. Examples of removable data storage media include Compact Disc Read-Only Memory (CD-ROM), Digital Versatile Disc Read-Only Memory (DVD-ROM), magneto-optical disks, flash drives, and the like. Examples of non-removable data storage media include internal magnetic hard disks, SSDs, and the like. The one or more memory devices 806 may include volatile memory (e.g., dynamic random access memory (DRAM), static random access memory (SRAM), etc.) and/or non-volatile memory (e.g., read-only memory (ROM), flash memory, etc.).

Computer program products containing mechanisms to effectuate the systems and methods in accordance with the presently described technology may reside in main memory 816, which may be referred to as machine-readable media. It will be appreciated that machine-readable media may include any tangible non-transitory medium that is capable of storing or encoding instructions to perform any one or more of the operations of the present disclosure for execution by a machine or that is capable of storing or encoding data structures and/or modules utilized by or associated with such instructions. Machine-readable media may include a single medium or multiple media (e.g., a centralized or distributed database, and/or associated caches and servers) that store the one or more executable instructions or data structures.

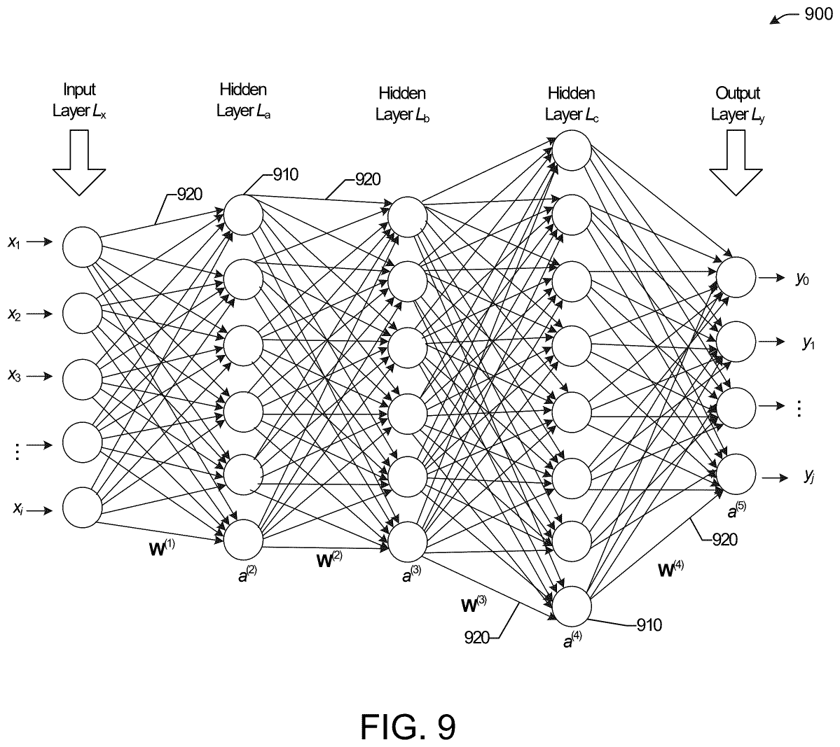

FIG. 9 illustrates an example neural network 900, in accordance with one or more embodiments. The example neural network (NN) 900 may be implemented to identify and classify digital handwriting and synthesize handwritten text to appear consistent with characteristics of a user's digital handwriting. The NN 900 may be deployed on the frontend user device and/or as a backend service. When deployed on the backend, the NN 900 may provide its outputs to the frontend.

The neural network (NN) 900 may be suitable for use by one or more of the computing systems (or subsystems) of the various implementations discussed herein, implemented in part by a HW accelerator, and/or the like. The NN 900 may be deep neural network (DNN) used as an artificial brain of a compute node or network of compute nodes to handle very large and complicated observation spaces. Additionally or alternatively, the NN 900 can be some other type of topology (or combination of topologies), such as a convolution NN (CNN), deep CNN (DCN), recurrent NN (RNN), Long Short Term Memory (LSTM) network, a Deconvolutional NN (DNN), gated recurrent unit (GRU), deep belief NN, a feed forward NN (FFN), a deep FNN (DFF), deep stacking network, Markov chain, perception NN, Bayesian Network (BN) or Bayesian NN (BNN), Dynamic BN (DBN), Linear Dynamical System (LDS), Switching LDS (SLDS), Optical NNs (ONNs), an NN for reinforcement learning (RL) and/or deep RL (DRL), and/or the like. NNs are usually used for supervised learning, but can be used for unsupervised learning and/or reinforcement (RL).

The NN 900 may encompass a variety of ML techniques where a collection of connected artificial neurons 910 that (loosely) model neurons in a biological brain that transmit signals to other neurons/nodes 910. The neurons 910 may also be referred to as nodes 910, processing elements (PEs) 910, or the like. The connections 920 (or edges 920) between the nodes 910 are (loosely) modeled on synapses of a biological brain and convey the signals between nodes 910. Note that not all neurons 910 and edges 920 are labeled in FIG. 9 for the sake of clarity.

Each neuron 910 has one or more inputs and produces an output, which can be sent to one or more other neurons 910 (the inputs and outputs may be referred to as “signals”). Inputs to the neurons 910 of the input layer L_x can be feature values of a sample of external data (e.g., input variables x_i). The input variables x_i can be set as a vector containing relevant data (e.g., observations, ML features, and the like). The inputs to hidden units 910 of the hidden layers L_a, L_b, and L_c may be based on the outputs of other neurons 910. The outputs of the final output neurons 910 of the output layer L_y (e.g., output variables y_j) include predictions, inferences, and/or accomplish a desired/configured task. The output variables y_j may be in the form of determinations, inferences, predictions, and/or assessments. Additionally or alternatively, the output variables y_j can be set as a vector containing the relevant data (e.g., determinations, inferences, predictions, assessments, and/or the like).

In the context of ML, an “ML feature” (or simply “feature”) is an individual measurable property or characteristic of a phenomenon being observed. Features are usually represented using numbers/numerals (e.g., integers), strings, variables, ordinals, real-values, categories, and/or the like. Additionally or alternatively, ML features are individual variables, which may be independent variables, based on observable phenomenon that can be quantified and recorded. ML models use one or more features to make predictions or inferences. In some implementations, new features can be derived from old features.

Neurons 910 may have a threshold such that a signal is sent only if the aggregate signal crosses that threshold. A node 910 may include an activation function, which defines the output of that node 910 given an input or set of inputs. Additionally or alternatively, a node 910 may include a propagation function that computes the input to a neuron 910 from the outputs of its predecessor neurons 910 and their connections 920 as a weighted sum. A bias term can also be added to the result of the propagation function.

The NN 900 also includes connections 920, some of which provide the output of at least one neuron 910 as an input to at least another neuron 910. Each connection 920 may be assigned a weight that represents its relative importance. The weights may also be adjusted as learning proceeds. The weight increases or decreases the strength of the signal at a connection 920.

The neurons 910 can be aggregated or grouped into one or more layers L where different layers L may perform different transformations on their inputs. In FIG. 9, the NN 900 comprises an input layer L_x, one or more hidden layers L_a, L_b, and L_c, and an output layer L_y (where a, b, c, x, and y may be numbers), where each layer L comprises one or more neurons 910. Signals travel from the first layer (e.g., the input layer L_1), to the last layer (e.g., the output layer L_y), possibly after traversing the hidden layers L_a, L_b, and L_cmultiple times. In FIG. 12, the input layer L_a receives data of input variables x_i (where i=1, . . . , p, where p is a number). Hidden layers L_a, L_b, and L_c processes the inputs x_i, and eventually, output layer L_y provides output variables y_j (where j=1, . . . , p′, where p′ is a number that is the same or different than p). In the example of FIG. 6, for simplicity of illustration, there are only three hidden layers L_a, L_b, and L_c in the NN 900, however, the NN 900 may include many more (or fewer) hidden layers L_a, L_b, and L_c than are shown.

For the purposes of the present document, the following terms and definitions are applicable to the examples and embodiments discussed herein.

The term “application” may refer to a complete and deployable package, environment to achieve a certain function in an operational environment. The term “AI/ML application” or the like may be an application that contains some AI/ML models and application-level descriptions.

The term “circuitry” as used herein refers to, is part of, or includes hardware components such as an electronic circuit, a logic circuit, a processor (shared, dedicated, or group) and/or memory (shared, dedicated, or group), an Application Specific Integrated Circuit (ASIC), a field-programmable device (FPD) (e.g., a field-programmable gate array (FPGA), a programmable logic device (PLD), a complex PLD (CPLD), a high-capacity PLD (HCPLD), a structured ASIC, or a programmable SoC), digital signal processors (DSPs), etc., that are configured to provide the described functionality. In some embodiments, the circuitry may execute one or more software or firmware programs to provide at least some of the described functionality. The term “circuitry” may also refer to a combination of one or more hardware elements (or a combination of circuits used in an electrical or electronic system) with the program code used to carry out the functionality of that program code. In these embodiments, the combination of hardware elements and program code may be referred to as a particular type of circuitry.

The term “processor circuitry” as used herein refers to, is part of, or includes circuitry capable of sequentially and automatically carrying out a sequence of arithmetic or logical operations, or recording, storing, and/or transferring digital data. Processing circuitry may include one or more processing cores to execute instructions and one or more memory structures to store program and data information. The term “processor circuitry” may refer to one or more application processors, one or more baseband processors, a physical central processing unit (CPU), a single-core processor, a dual-core processor, a triple-core processor, a quad-core processor, and/or any other device capable of executing or otherwise operating computer-executable instructions, such as program code, software modules, and/or functional processes. Processing circuitry may include more hardware accelerators, which may be microprocessors, programmable processing devices, or the like. The one or more hardware accelerators may include, for example, computer vision (CV) and/or deep learning (DL) accelerators. The terms “application circuitry” and/or “baseband circuitry” may be considered synonymous to, and may be referred to as, “processor circuitry.”

The term “memory” and/or “memory circuitry” at least in some examples refers to one or more hardware devices for storing data, including random access memory (RAM), static RAM (SRAM), dynamic RAM (DRAM), synchronous DRAM (SDRAM), magnetoresistive RAM (MRAM), conductive bridge Random Access Memory (CB-RAM), spin transfer torque (STT)-MRAM, phase change RAM (PRAM), core memory, read-only memory (ROM), programmable ROM (PROM), erasable PROM (EPROM), electrically EPROM (EEPROM), flash memory, non-volatile RAM (NVRAM), magnetic disk storage mediums, optical storage mediums, flash memory devices or other machine readable mediums for storing data. The term “computer-readable medium” includes, but is not limited to, memory, portable or fixed storage devices, optical storage devices, and various other mediums capable of storing, containing or carrying instructions or data.

The terms “machine-readable medium” and “computer-readable medium” refers to tangible medium that is capable of storing, encoding or carrying instructions for execution by a machine and that cause the machine to perform any one or more of the methodologies of the present disclosure or that is capable of storing, encoding or carrying data structures utilized by or associated with such instructions. A “machine-readable medium” thus includes but is not limited to, solid-state memories, and optical and magnetic media. Specific examples of machine-readable media include non-volatile memory, including but not limited to, by way of example, semiconductor memory devices (e.g., electrically programmable read-only memory (EPROM), electrically erasable programmable read-only memory (EEPROM)) and flash memory devices; magnetic disks such as internal hard disks and removable disks; magneto-optical disks; and CD-ROM and DVD-ROM disks. The instructions embodied by a machine-readable medium may further be transmitted or received over a communications network using a transmission medium via a network interface device utilizing any one of a number of transfer protocols (e.g., HTTP). A machine-readable medium may be provided by a storage device or other apparatus which is capable of hosting data in a non-transitory format. In an example, information stored or otherwise provided on a machine-readable medium may be representative of instructions, such as instructions themselves or a format from which the instructions may be derived. This format from which the instructions may be derived includes source code, encoded instructions (e.g., in compressed or encrypted form), packaged instructions (e.g., split into multiple packages), or the like. The information representative of the instructions in the machine-readable medium may be processed by processing circuitry into the instructions to implement any of the operations discussed herein. For example, deriving the instructions from the information (e.g., processing by the processing circuitry) includes: compiling (e.g., from source code, object code, and/or the like), interpreting, loading, organizing (e.g., dynamically or statically linking), encoding, decoding, encrypting, unencrypting, packaging, unpackaging, or otherwise manipulating the information into the instructions. In an example, the derivation of the instructions includes assembly, compilation, or interpretation of the information (e.g., by the processing circuitry) to create the instructions from some intermediate or preprocessed format provided by the machine-readable medium. The information, when provided in multiple parts, may be combined, unpacked, and modified to create the instructions. For example, the information may be in multiple compressed source code packages (or object code, or binary executable code, and/or the like) on one or several remote servers. The source code packages may be encrypted when in transit over a network and decrypted, uncompressed, assembled (e.g., linked) if necessary, and compiled or interpreted (e.g., into a library, stand-alone executable, and/or the like) at a local machine, and executed by the local machine. The terms “machine-readable medium” and “computer-readable medium” may be interchangeable for purposes of the present disclosure. The term “non-transitory computer-readable medium at least in some examples refers to any type of memory, computer readable storage device, and/or storage disk and may exclude propagating signals and transmission media.

The term “artificial intelligence” or “AI” at least in some examples refers to any intelligence demonstrated by machines, in contrast to the natural intelligence displayed by humans and other animals. Additionally or alternatively, the term “artificial intelligence” or “AI” at least in some examples refers to the study of “intelligent agents” and/or any device that perceives its environment and takes actions that maximize its chance of successfully achieving a goal.

The terms “artificial neural network”, “neural network”, or “NN” refer to an ML technique comprising a collection of connected artificial neurons or nodes that (loosely) model neurons in a biological brain that can transmit signals to other arterial neurons or nodes, where connections (or edges) between the artificial neurons or nodes are (loosely) modeled on synapses of a biological brain. The artificial neurons and edges typically have a weight that adjusts as learning proceeds. The weight increases or decreases the strength of the signal at a connection. Neurons may have a threshold such that a signal is sent only if the aggregate signal crosses that threshold. The artificial neurons can be aggregated or grouped into one or more layers where different layers may perform different transformations on their inputs. Signals travel from the first layer (the input layer), to the last layer (the output layer), possibly after traversing the layers multiple times. NNs are usually used for supervised learning, but can be used for unsupervised learning as well. Examples of NNs include deep NN (DNN), feed forward NN (FFN), deep FNN (DFF), convolutional NN (CNN), deep CNN (DCN), deconvolutional NN (DNN), a deep belief NN, a perception NN, recurrent NN (RNN) (e.g., including Long Short Term Memory (LSTM) algorithm, gated recurrent unit (GRU), echo state network (ESN), and the like), spiking NN (SNN), deep stacking network (DSN), Markov chain, perception NN, generative adversarial network (GAN), transformers, stochastic NNs (e.g., Bayesian Network (BN), Bayesian belief network (BBN), a Bayesian NN (BNN), Deep BNN (DBNN), Dynamic BN (DBN), probabilistic graphical model (PGM), Boltzmann machine, restricted Boltzmann machine (RBM), Hopfield network or Hopfield NN, convolutional deep belief network (CDBN), and the like), Linear Dynamical System (LDS), Switching LDS (SLDS), Optical NNs (ONNs), an NN for reinforcement learning (RL) and/or deep RL (DRL), and/or the like.

The term “attention” in the context of machine learning and/or neural networks, at least in some examples refers to a technique that mimics cognitive attention, which enhances important parts of a dataset where the important parts of the dataset may be determined using training data by gradient descent. The term “dot-product attention” at least in some examples refers to an attention technique that uses the dot product between vectors to determine attention. The term “multi-head attention” at least in some examples refers to an attention technique that combines several different attention mechanisms to direct the overall attention of a network or subnetwork.

The term “attention model” or “attention mechanism” at least in some examples refers to input processing techniques for neural networks that allow the neural network to focus on specific aspects of a complex input, one at a time until the entire dataset is categorized. The goal is to break down complicated tasks into smaller areas of attention that are processed sequentially. Similar to how the human mind solves a new problem by dividing it into simpler tasks and solving them one by one. The term “attention network” at least in some examples refers to an artificial neural networks used for attention in machine learning.

The term “backpropagation” at least in some examples refers to a method used in NNs to calculate a gradient that is needed in the calculation of weights to be used in the NN; “backpropagation” is shorthand for “the backward propagation of errors.” Additionally or alternatively, the term “backpropagation” at least in some examples refers to a method of calculating the gradient of neural network parameters. Additionally or alternatively, the term “backpropagation” or “back pass” at least in some examples refers to a method of traversing a neural network in reverse order, from the output to the input layer.

The term “Bayesian optimization” at least in some examples refers to a sequential design strategy for global optimization of black-box functions that does not assume any functional forms. Additionally or alternatively, the term “Bayesian optimization” at least in some examples refers to an optimization technique based upon the minimization of an expected deviation from an extremum. At least in some examples, Bayesian optimization minimizes an objective function by building a probability model based on past evaluation results of the objective.

The term “classification” in the context of machine learning at least in some examples refers to an ML technique for determining the classes to which various data points belong. Here, the term “class” or “classes” at least in some examples refers to categories, and are sometimes called “targets” or “labels.” Classification is used when the outputs are restricted to a limited set of quantifiable properties. Classification algorithms may describe an individual (data) instance whose category is to be predicted using a feature vector. As an example, when the instance includes a collection (corpus) of text, each feature in a feature vector may be the frequency that specific words appear in the corpus of text. In ML classification, labels are assigned to instances, and models are trained to correctly predict the pre-assigned labels of from the training examples. ML algorithms for classification may be referred to as a “classifier.” Examples of classifiers include linear classifiers, k-nearest neighbor (kNN), decision trees, random forests, support vector machines (SVMs), Bayesian classifiers, convolutional neural networks (CNNs), among many others (note that some of these algorithms can be used for other ML tasks as well).

The term “computational graph” at least in some examples refers to a data structure that describes how an output is produced from one or more inputs.

The term “converge” or “convergence” at least in some examples refers to the stable point found at the end of a sequence of solutions via an iterative optimization algorithm. Additionally or alternatively, the term “converge” or “convergence” at least in some examples refers to the output of a function or algorithm getting closer to a specific value over multiple iterations of the function or algorithm.

The term “convolution” at least in some examples refers to a convolutional operation or a convolutional layer of a CNN.

The term “convolutional filter” at least in some examples refers to a matrix having the same rank as an input matrix, but a smaller shape. In machine learning, a convolutional filter is mixed with an input matrix in order to train weights.

The term “convolutional layer” at least in some examples refers to a layer of a DNN in which a convolutional filter passes along an input matrix (e.g., a CNN). Additionally or alternatively, the term “convolutional layer” at least in some examples refers to a layer that includes a series of convolutional operations, each acting on a different slice of an input matrix.

The term “convolutional neural network” or “CNN” at least in some examples refers to a neural network including at least one convolutional layer. Additionally or alternatively, the term “convolutional neural network” or “CNN” at least in some examples refers to a DNN designed to process structured arrays of data such as images.

The term “convolutional operation” at least in some examples refers to a mathematical operation on two functions (e.g., and) that produces a third function ( ) that expresses how the shape of one is modified by the other where the term “convolution” may refer to both the result function and to the process of computing it. Additionally or alternatively, term “convolutional” at least in some examples refers to the integral of the product of the two functions after one is reversed and shifted, where the integral is evaluated for all values of shift, producing the convolution function. Additionally or alternatively, term “convolutional” at least in some examples refers to a two-step mathematical operation includes element-wise multiplication of the convolutional filter and a slice of an input matrix (the slice of the input matrix has the same rank and size as the convolutional filter); and (2) summation of all the values in the resulting product matrix.

The term “covariance” at least in some examples refers to a measure of the joint variability of two random variables, wherein the covariance is positive if the greater values of one variable mainly correspond with the greater values of the other variable (and the same holds for the lesser values such that the variables tend to show similar behavior), and the covariance is negative when the greater values of one variable mainly correspond to the lesser values of the other.

The term “ensemble averaging” at least in some examples refers to the process of creating multiple models and combining them to produce a desired output, as opposed to creating just one model.

The term “ensemble learning” or “ensemble method” at least in some examples refers to using multiple learning algorithms to obtain better predictive performance than could be obtained from any of the constituent learning algorithms alone.

The term “epoch” at least in some examples refers to one cycle through a full training dataset. Additionally or alternatively, the term “epoch” at least in some examples refers to a full training pass over an entire training dataset such that each training example has been seen once; here, an epoch represents N/batch size training iterations, where N is the total number of examples.

The term “event”, in probability theory, at least in some examples refers to a set of outcomes of an experiment (e.g., a subset of a sample space) to which a probability is assigned. Additionally or alternatively, the term “event” at least in some examples refers to a software message indicating that something has happened. Additionally or alternatively, the term “event” at least in some examples refers to an object in time, or an instantiation of a property in an object. Additionally or alternatively, the term “event” at least in some examples refers to a point in space at an instant in time (e.g., a location in spacetime). Additionally or alternatively, the term “event” at least in some examples refers to a notable occurrence at a particular point in time.

The term “experiment” in probability theory, at least in some examples refers to any procedure that can be repeated and has a well-defined set of outcomes, known as a sample space.

The term “F score” or “F measure” at least in some examples refers to a measure of a test's accuracy that may be calculated from the precision and recall of a test or model. The term “F1 score” at least in some examples refers to the harmonic mean of the precision and recall, and the term “Fβ score” at least in some examples refers to an F-score having additional weights that emphasize or value one of precision or recall more than the other.

The term “feature” at least in some examples refers to an individual measurable property, quantifiable property, or characteristic of a phenomenon being observed. Additionally or alternatively, the term “feature” at least in some examples refers to an input variable used in making predictions. At least in some examples, features may be represented using numbers/numerals (e.g., integers), strings, variables, ordinals, real-values, categories, and/or the like.

The term “feature engineering” at least in some examples refers to a process of determining which features might be useful in training an ML model, and then converting raw data into the determined features. Feature engineering is sometimes referred to as “feature extraction.”

The term “feature extraction” at least in some examples refers to a process of dimensionality reduction by which an initial set of raw data is reduced to more manageable groups for processing. Additionally or alternatively, the term “feature extraction” at least in some examples refers to retrieving intermediate feature representations calculated by an unsupervised model or a pretrained model for use in another model as an input. Feature extraction is sometimes used as a synonym of “feature engineering.”

The term “feature map” at least in some examples refers to a function that takes feature vectors (or feature tensors) in one space and transforms them into feature vectors (or feature tensors) in another space. Additionally or alternatively, the term “feature map” at least in some examples refers to a function that maps a data vector (or tensor) to feature space. Additionally or alternatively, the term “feature map” at least in some examples refers to a function that applies the output of one filter applied to a previous layer. In some embodiments, the term “feature map” may also be referred to as an “activation map”.

The term “feature vector” at least in some examples, in the context of ML, refers to a set of features and/or a list of feature values representing an example passed into a model. Additionally or alternatively, the term “feature vector” at least in some examples, in the context of ML, refers to a vector that includes a tuple of one or more features.

The term “forward propagation” or “forward pass” at least in some examples, in the context of ML, refers to the calculation and storage of intermediate variables (including outputs) for a neural network in order from the input layer to the output layer.

The term “hidden layer”, in the context of ML and NNs, at least in some examples refers to an internal layer of neurons in an ANN that is not dedicated to input or output. The term “hidden unit” refers to a neuron in a hidden layer in an ANN.

The term “hyperparameter” at least in some examples refers to characteristics, properties, and/or parameters for an ML process that cannot be learnt during a training process. Hyperparameter are usually set before training takes place, and may be used in processes to help estimate model parameters. Examples of hyperparameters include model size (e.g., in terms of memory space, bytes, number of layers, and the like); training data shuffling (e.g., whether to do so and by how much); number of evaluation instances, iterations, epochs (e.g., a number of iterations or passes over the training data), or episodes; number of passes over training data; regularization; learning rate (e.g., the speed at which the algorithm reaches (converges to) optimal weights); learning rate decay (or weight decay); momentum; number of hidden layers; size of individual hidden layers; weight initialization scheme; dropout and gradient clipping thresholds; the C value and sigma value for SVMs; the k in k-nearest neighbors; number of branches in a decision tree; number of clusters in a clustering algorithm; vector size; word vector size for NLP and NLU; and/or the like.

The term “inference engine” at least in some examples refers to a component of a computing system that applies logical rules to a knowledge base to deduce new information.

The terms “instance-based learning” or “memory-based learning” in the context of ML at least in some examples refers to a family of learning algorithms that, instead of performing explicit generalization, compares new problem instances with instances seen in training, which have been stored in memory. Examples of instance-based algorithms include k-nearest neighbor, and the like), decision tree Algorithms (e.g., Classification And Regression Tree (CART), Iterative Dichotomiser 3 (ID3), C4.5, chi-square automatic interaction detection (CHAID), and the like), Fuzzy Decision Tree (FDT), and the like), Support Vector Machines (SVM), Bayesian Algorithms (e.g., Bayesian network (BN), a dynamic BN (DBN), Naive Bayes, and the like), and ensemble algorithms (e.g., Extreme Gradient Boosting, voting ensemble, bootstrap aggregating (“bagging”), Random Forest and the like.

The term “intelligent agent” at least in some examples refers to a software agent or other autonomous entity which acts, directing its activity towards achieving goals upon an environment using observation through sensors and consequent actuators (e.g. it is intelligent). Intelligent agents may also learn or use knowledge to achieve their goals.

The term “iteration” at least in some examples refers to the repetition of a process in order to generate a sequence of outcomes, wherein each repetition of the process is a single iteration, and the outcome of each iteration is the starting point of the next iteration. Additionally or alternatively, the term “iteration” at least in some examples refers to a single update of a model's weights during training.

The term “Kullback-Leibler divergence” at least in some examples refers to a measure of how one probability distribution is different from a reference probability distribution. The “Kullback-Leibler divergence” may be a useful distance measure for continuous distributions and is often useful when performing direct regression over the space of (discretely sampled) continuous output distributions. The term “Kullback-Leibler divergence” may also be referred to as “relative entropy”.

The term “knowledge base” at least in some examples refers to any technology used to store complex structured and/or unstructured information used by a computing system.

The term “knowledge distillation” in machine learning, at least in some examples refers to the process of transferring knowledge from a large model to a smaller one.

The term “logit” at least in some examples refers to a set of raw predictions (e.g., non-normalized predictions) that a classification model generates, which is ordinarily then passed to a normalization function such as a softmax function for models solving a multi-class classification problem. Additionally or alternatively, the term “logit” at least in some examples refers to a logarithm of a probability. Additionally or alternatively, the term “logit” at least in some examples refers to the output of a logit function. Additionally or alternatively, the term “logit” or “logit function” at least in some examples refers to a quantile function associated with a standard logistic distribution. Additionally or alternatively, the term “logit” at least in some examples refers to the inverse of a standard logistic function. Additionally or alternatively, the term “logit” at least in some examples refers to the element-wise inverse of the sigmoid function. Additionally or alternatively, the term “logit” or “logit function” at least in some examples refers to a function that represents probability values from 0 to 1, and negative infinity to infinity. Additionally or alternatively, the term “logit” or “logit function” at least in some examples refers to a function that takes a probability and produces a real number between negative and positive infinity.

The term “loss function” or “cost function” at least in some examples refers to an event or values of one or more variables onto a real number that represents some “cost” associated with the event. A value calculated by a loss function may be referred to as a “loss” or “error”. Additionally or alternatively, the term “loss function” or “cost function” at least in some examples refers to a function used to determine the error or loss between the output of an algorithm and a target value. Additionally or alternatively, the term “loss function” or “cost function” at least in some examples refers to a function are used in optimization problems with the goal of minimizing a loss or error.

The term “mathematical model” at least in some examples refer to a system of postulates, data, and inferences presented as a mathematical description of an entity or state of affairs including governing equations, assumptions, and constraints. The term “statistical model” at least in some examples refers to a mathematical model that embodies a set of statistical assumptions concerning the generation of sample data and/or similar data from a population; in some examples, a “statistical model” represents a data-generating process.

The term “machine learning” or “ML” at least in some examples refers to the use of computer systems to optimize a performance criterion using example (training) data and/or past experience. ML involves using algorithms to perform specific task(s) without using explicit instructions to perform the specific task(s), and/or relying on patterns, predictions, and/or inferences. ML uses statistics to build ML model(s) (also referred to as “models”) in order to make predictions or decisions based on sample data (e.g., training data).

The term “machine learning model” or “ML model” at least in some examples refers to an application, program, process, algorithm, and/or function that is capable of making predictions, inferences, or decisions based on an input data set and/or is capable of detecting patterns based on an input data set. In some examples, a “machine learning model” or “ML model” is trained on a training data to detect patterns and/or make predictions, inferences, and/or decisions. In some examples, a “machine learning model” or “ML model” is based on a mathematical and/or statistical model. For purposes of the present disclosure, the terms “ML model”, “AI model”, “AI/ML model”, and the like may be used interchangeably.

The term “machine learning algorithm” or “ML algorithm” at least in some examples refers to an application, program, process, algorithm, and/or function that builds or estimates an ML model based on sample data or training data. Additionally or alternatively, the term “machine learning algorithm” or “ML algorithm” at least in some examples refers to a program, process, algorithm, and/or function that learns from experience w.r.t some task(s) and some performance measure(s)/metric(s), and an ML model is an object or data structure created after an ML algorithm is trained with training data. For purposes of the present disclosure, the terms “ML algorithm”, “AI algorithm”, “AI/ML algorithm”, and the like may be used interchangeably. Additionally, although the term “ML algorithm” may refer to different concepts than the term “ML model,” these terms may be used interchangeably for the purposes of the present disclosure.

The term “machine learning application” or “ML application” at least in some examples refers to an application, program, process, algorithm, and/or function that contains some AI/ML model(s) and application-level descriptions. Additionally or alternatively, the term “machine learning application” or “ML application” at least in some examples refers to a complete and deployable application and/or package that includes at least one ML model and/or other data capable of achieving a certain function and/or performing a set of actions or tasks in an operational environment. For purposes of the present disclosure, the terms “ML application”, “AI application”, “AI/ML application”, and the like may be used interchangeably.

The term “machine learning entity” or “ML entity” at least in some examples refers to an entity that is either an ML model or contains an ML model and ML model-related metadata that can be managed as a single composite entity (in some examples, metadata may include, for example, the applicable runtime context for the ML model). For purposes of the present disclosure, the term “AI/ML entity” or “ML entity” at least in some examples refers to an entity that is either an AI/ML model and/or contains an AI/ML model and that can be managed as a single composite entity. Additionally, the term “ML entity training” at least in some examples refers to ML model training associated with an ML entity. Moreover, the term “AI/ML” may be used interchangeably with the terms “AI” and “ML” throughout the present disclosure.

The term “AI decision entity”, “machine learning decision entity”, or “ML decision entity” at least in some examples refers to an entity that applies a non-AI and/or non-ML based logic for making decisions that can be managed as a single composite entity.

The term “machine learning training”, “ML training”, or “MLT” at least in some examples refers to capabilities and associated end-to-end (e2e) processes to enable an ML training function to perform ML entity (or ML model) training (e.g., as defined herein). In some examples, ML training capabilities include interaction with other parties/entities to collect and/or format the data required for ML model training. Additionally or alternatively, “training an ML entity” refers to training one or more ML model(s) associated with an ML entity internally by an MLT function.

The term “machine learning model training” or “ML model training” at least in some examples refers to capabilities of an ML training function to take data, run the data through an ML model, derive associated loss, optimization, and/or objective/goal, and adjust the parameterization of the ML model based on the computed loss, optimization, and/or objective/goal.

The term “ML initial training” at least in some examples refers to ML entity training that generates an initial version of a trained ML entity.

The term “ML re-training” at least in some examples refers to MLT that generates a new version of a trained ML entity using the same type, but different values or distributions, of training data as that used to train the previous version of the ML entity. This new version of the trained ML entity (e.g., the re-trained ML entity) supports the same type of inference as the previous version of the ML entity, e.g., the data type of inference input and data type of inference output remain unchanged between the two versions of the ML entity

The term “machine learning training function”, “ML training function”, or “MLT function” at least in some examples refers to a (logical) function with MLT capabilities.

The term “AI/ML inference function” or “ML inference function” at least in some examples refers to a (logical) function (or set of functions) that employs an ML model and/or AI decision entity to conduct inference. Additionally or alternatively, the term “AI/ML inference function” or “ML inference function” at least in some examples refers to an inference framework used to run a compiled model in the inference host. In some examples, an “AI/ML inference function” or “ML inference function” may also be referred to an “model inference engine”, “ML inference engine”, or “inference engine”.

The term “machine learning workflow” or “ML workflow” at least in some examples refers to a process including data collection and preparation, AI/ML model building/generation; ML model training and testing; ML model deployment, ML model execution, ML model validation and/or verification; continuous, periodic and/or asynchronous ML model monitoring; ML model tuning, learning, and/or retraining. In some examples, the ML model monitoring includes self-monitoring or autonomous monitoring). In some examples, the ML model tuning, learning, and/or retraining includes self-tuning (or autonomous tuning), self-learning (or autonomous learning), and/or self-retraining (or autonomous retraining). The term “machine learning lifecycle” or “ML lifecycle” at least in some examples refers to process(es) of planning and/or managing the development, deployment, instantiation, and/or termination of an ML model and/or individual ML model components.

The term “matrix” at least in some examples refers to a rectangular array of numbers, symbols, or expressions, arranged in rows and columns, which may be used to represent an object or a property of such an object.

The terms “model parameter” and/or “parameter” in the context of ML, at least in some examples refer to values, characteristics, and/or properties that are learnt during training. Additionally or alternatively, “model parameter” and/or “parameter” in the context of ML, at least in some examples refer to a configuration variable that is internal to the model and whose value can be estimated from the given data. Model parameters are usually required by a model when making predictions, and their values define the skill of the model on a particular problem. Examples of such model parameters/parameters include weights (e.g., in an ANN); constraints; support vectors in a support vector machine (SVM); coefficients in a linear regression and/or logistic regression; word frequency, sentence length, noun or verb distribution per sentence, the number of specific character n-grams per word, lexical diversity, and the like, for natural language processing (NLP) and/or natural language understanding (NLU); and/or the like.

The term “momentum” at least in some examples refers to an aggregate of gradients in gradient descent. Additionally or alternatively, the term “momentum” at least in some examples refers to a variant of the stochastic gradient descent algorithm where a current gradient is replaced with m (momentum), which is an aggregate of gradients.

The term “objective function” at least in some examples refers to a function to be maximized or minimized for a specific optimization problem. In some cases, an objective function is defined by its decision variables and an objective. The objective is the value, target, or goal to be optimized, such as maximizing profit or minimizing usage of a particular resource. The specific objective function chosen depends on the specific problem to be solved and the objectives to be optimized. Constraints may also be defined to restrict the values the decision variables can assume thereby influencing the objective value (output) that can be achieved. During an optimization process, an objective function's decision variables are often changed or manipulated within the bounds of the constraints to improve the objective function's values. In general, the difficulty in solving an objective function increases as the number of decision variables included in that objective function increases. The term “decision variable” refers to a variable that represents a decision to be made.

The term “optimization” at least in some examples refers to an act, process, or methodology of making something (e.g., a design, system, or decision) as fully perfect, functional, or effective as possible. Optimization usually includes mathematical procedures such as finding the maximum or minimum of a function. The term “optimal” at least in some examples refers to a most desirable or satisfactory end, outcome, or output. The term “optimum” at least in some examples refers to an amount or degree of something that is most favorable to some end. The term “optima” at least in some examples refers to a condition, degree, amount, or compromise that produces a best possible result. Additionally or alternatively, the term “optima” at least in some examples refers to a most favorable or advantageous outcome or result.

The term “probability” at least in some examples refers to a numerical description of how likely an event is to occur and/or how likely it is that a proposition is true. The term “probability distribution” at least in some examples refers to a mathematical function that gives the probabilities of occurrence of different possible outcomes for an experiment or event.

The term “probability distribution” at least in some examples refers to a function that gives the probabilities of occurrence of different possible outcomes for an experiment or event. Additionally or alternatively, the term “probability distribution” at least in some examples refers to a statistical function that describes all possible values and likelihoods that a random variable can take within a given range (e.g., a bound between minimum and maximum possible values). A probability distribution may have one or more factors or attributes such as, for example, a mean or average, mode, support, tail, head, median, variance, standard deviation, quantile, symmetry, skewness, kurtosis, and the like. A probability distribution may be a description of a random phenomenon in terms of a sample space and the probabilities of events (subsets of the sample space). Example probability distributions include discrete distributions (e.g., Bernoulli distribution, discrete uniform, binomial, Dirac measure, Gauss-Kuzmin distribution, geometric, hypergeometric, negative binomial, negative hypergeometric, Poisson, Poisson binomial, Rademacher distribution, Yule-Simon distribution, zeta distribution, Zipf distribution, and the like), continuous distributions (e.g., Bates distribution, beta, continuous uniform, normal distribution, Gaussian distribution, bell curve, joint normal, gamma, chi-squared, non-central chi-squared, exponential, Cauchy, lognormal, logit-normal, F distribution, t distribution, Dirac delta function, Pareto distribution, Lomax distribution, Wishart distribution, Weibull distribution, Gumbel distribution, Irwin-Hall distribution, Gompertz distribution, inverse Gaussian distribution (or Wald distribution), Chernoff's distribution, Laplace distribution, Pólya-Gamma distribution, and the like), and/or joint distributions (e.g., Dirichlet distribution, Ewens's sampling formula, multinomial distribution, multivariate normal distribution, multivariate t-distribution, Wishart distribution, matrix normal distribution, matrix t distribution, and the like).

The term “probability distribution function” at least in some examples refers to an integral of the probability density function.

The term “probability density function” or “PDF” at least in some examples refers to a function whose value at any given sample (or point) in a sample space can be interpreted as providing a relative likelihood that the value of the random variable would be close to that sample. Additionally or alternatively, the term “probability density function” or “PDF” at least in some examples refers to a probability of a random variable falling within a particular range of values. Additionally or alternatively, the term “probability density function” or “PDF” at least in some examples refers to a value at two different samples can be used to infer, in any particular draw of the random variable, how much more likely it is that the random variable would be close to one sample compared to the other sample.

The term “precision” at least in some examples refers to the closeness of the two or more measurements to each other. The term “precision” may also be referred to as “positive predictive value”.

The term “predictive service” at least in some examples refers to a service model which provides reliable performance, but allowing a specified variance in the measured performance criteria.

The terms “regression algorithm” and/or “regression analysis” in the context of ML at least in some examples refers to a set of statistical processes for estimating the relationships between a dependent variable (often referred to as the “outcome variable”) and one or more independent variables (often referred to as “predictors”, “covariates”, or “features”). Examples of regression algorithms/models include logistic regression, linear regression, gradient descent (GD), stochastic GD (SGD), and the like.

The term “reinforcement learning” or “RL” at least in some examples refers to a goal-oriented learning technique based on interaction with an environment. In RL, an agent aims to optimize a long-term objective by interacting with the environment based on a trial and error process. Examples of RL algorithms include Markov decision process, Markov chain, Q-learning, multi-armed bandit learning, temporal difference learning, and deep RL. The term “multi-armed bandit problem”, “K-armed bandit problem”, “N-armed bandit problem”, or “contextual bandit” at least in some examples refers to a problem in which a fixed limited set of resources must be allocated between competing (alternative) choices in a way that maximizes their expected gain, when each choice's properties are only partially known at the time of allocation, and may become better understood as time passes or by allocating resources to the choice. The term “contextual multi-armed bandit problem” or “contextual bandit” at least in some examples refers to a version of multi-armed bandit where, in each iteration, an agent has to choose between arms; before making the choice, the agent sees a d-dimensional feature vector (context vector) associated with a current iteration, the learner uses these context vectors along with the rewards of the arms played in the past to make the choice of the arm to play in the current iteration, and over time the learner's aim is to collect enough information about how the context vectors and rewards relate to each other, so that it can predict the next best arm to play by looking at the feature vectors.

The term “reward function”, in the context of RL, at least in some examples refers to a function that outputs a reward value based on one or more reward variables; the reward value provides feedback for an RL policy so that an RL agent can learn a desirable behavior. The term “reward shaping”, in the context of RL, at least in some examples refers to a adjusting or altering a reward function to output a positive reward for desirable behavior and a negative reward for undesirable behavior.

The term “sample space” in probability theory (also referred to as a “sample description space” or “possibility space”) of an experiment or random trial at least in some examples refers to a set of all possible outcomes or results of that experiment.

The term “search space”, in the context of optimization, at least in some examples refers to an a domain of a function to be optimized. Additionally or alternatively, the term “search space”, in the context of search algorithms, at least in some examples refers to a feasible region defining a set of all possible solutions. Additionally or alternatively, the term “search space” at least in some examples refers to a subset of all hypotheses that are consistent with the observed training examples. Additionally or alternatively, the term “search space” at least in some examples refers to a version space, which may be developed via machine learning.

The term “self-attention” at least in some examples refers to an attention mechanism relating different positions of a single sequence in order to compute a representation of the sequence. Additionally or alternatively, the term “self-attention” at least in some examples refers to an attention mechanism applied to a single context instead of across multiple contexts wherein queries, keys, and values are extracted from the same context.

The term “softmax” or “softmax function” at least in some examples refers to a generalization of the logistic function to multiple dimensions; the “softmax function” is used in multinomial logistic regression and is often used as the last activation function of a neural network to normalize the output of a network to a probability distribution over predicted output classes.

The term “supervised learning” at least in some examples refers to an ML technique that aims to learn a function or generate an ML model that produces an output given a labeled data set. Supervised learning algorithms build models from a set of data that contains both the inputs and the desired outputs. For example, supervised learning involves learning a function or model that maps an input to an output based on example input-output pairs or some other form of labeled training data including a set of training examples. Each input-output pair includes an input object (e.g., a vector) and a desired output object or value (referred to as a “supervisory signal”). Supervised learning can be grouped into classification algorithms, regression algorithms, and instance-based algorithms.

The term “tensor” at least in some examples refers to an object or other data structure represented by an array of components that describe functions relevant to coordinates of a space. Additionally or alternatively, the term “tensor” at least in some examples refers to a generalization of vectors and matrices and/or may be understood to be a multidimensional array. Additionally or alternatively, the term “tensor” at least in some examples refers to an array of numbers arranged on a regular grid with a variable number of axes. At least in some examples, a tensor can be defined as a single point, a collection of isolated points, or a continuum of points in which elements of the tensor are functions of position, and the Tensor forms a “tensor field”. At least in some examples, a vector may be considered as a one dimensional (1D) or first order tensor, and a matrix may be considered as a two dimensional (2D) or second order tensor. Tensor notation may be the same or similar as matrix notation with a capital letter representing the tensor and lowercase letters with subscript integers representing scalar values within the tensor.

The term “tuning” or “tune” at least in some examples refers to a process of adjusting model parameters or hyperparameters of an ML model in order to improve its performance. Additionally or alternatively, the term “tuning” or “tune” at least in some examples refers to a optimizing an ML model's model parameters and/or hyperparameters. In some examples, the particular model parameters and/or hyperparameters that are selected for adjustment, and the optimal values for the model parameters and/or hyperparameters vary depending on various aspects of the ML model, the training data, ML application and/or use cases, and/or other parameters, conditions, or criteria.

The term “unsupervised learning” at least in some examples refers to an ML technique that aims to learn a function to describe a hidden structure from unlabeled data. Unsupervised learning algorithms build models from a set of data that contains only inputs and no desired output labels. Unsupervised learning algorithms are used to find structure in the data, like grouping or clustering of data points. Examples of unsupervised learning are K-means clustering, principal component analysis (PCA), and topic modeling, among many others. The term “semi-supervised learning at least in some examples refers to ML algorithms that develop ML models from incomplete training data, where a portion of the sample input does not include labels.

The term “vector” at least in some examples refers to a one-dimensional array data structure. Additionally or alternatively, the term “vector” at least in some examples refers to a tuple of one or more values called scalars.

The terms “sparse vector”, “sparse matrix”, and “sparse array” at least in some examples refer to an input vector, matrix, or array including both non-zero elements and zero elements.

The terms “dense vector”, “dense matrix”, and “dense array” at least in some examples refer to an input vector, matrix, or array including all non-zero elements.

The following examples are not meant to be exclusive.

Embodiments of the present disclosure include various steps, which are described in this specification. The steps may be performed by hardware components or may be embodied in machine-executable instructions, which may be used to cause a general-purpose or special-purpose processor programmed with the instructions to perform the steps. Alternatively, the steps may be performed by a combination of hardware, software and/or firmware.

Various modifications and additions can be made to the exemplary embodiments discussed without departing from the scope of the present invention. For example, while the embodiments described above refer to particular features, the scope of this invention also includes embodiments having different combinations of features and embodiments that do not include all of the described features. Accordingly, the scope of the present invention is intended to embrace all such alternatives, modifications, and variations together with all equivalents thereof.

What is claimed:

1. A method for reflow of digitally entered handwritten characters into a device, the method comprising:
receiving handwritten strokes digitally entered into a text container presented using a device;
generating, using a first model, first groups of the handwritten strokes into text lines;
generating, using a second model, second groups of the handwritten strokes into words along the text lines;
determining, using a baseline estimation algorithm, a respective baseline for each of the text lines;
identifying, for each respective baseline, a lowest x-coordinate of the handwritten strokes;
determining, for each of the words, a distance between a respective word on a respective baseline and a consecutive word on the respective baseline;
determining, based on a width of the text container, the respective baselines, and the distance, a placement of each of the words in the text container; and
causing presentation, using the device, of the words in the text container based on the placement.

2. The method of claim 1, wherein the first model is a line segmentation model, and wherein the second model is a word segmentation model.

3. The method of claim 1, wherein the placement of a left-most word along a respective baseline is based on a left-side border of the text container.

4. The method of claim 1, wherein the placement of a left-most word along a respective baseline is based on the lowest x-coordinate of the left-most word.

5. The method of claim 1, further comprising:
determining a second distance between a respective word along a respective baseline and a right-most border of the text container; and
determining that a length of a next word, following the respective word, and the distance between the respective word and the next word is less than the second distance,
wherein the next word is placed along the respective baseline following the respective word based on the length of the next word and the distance between the respective word and the next word being less than the second distance.

6. The method of claim 1, further comprising:
determining a second distance between a respective word along a respective baseline and a right-most border of the text container; and
determining that a length of a next word, following the respective word, and the distance between the respective word and the next word is greater than the second distance,
wherein the next word is placed along a next baseline below the respective baseline based on the length of the next word and the distance between the respective word and the next word being greater than the second distance.

7. The method of claim 6, further comprising:
generating the next baseline below the respective baseline based on the length of the next word and the distance between the respective word and the next word being greater than the second distance.

8. The method of claim 1, further comprising:
receiving a user input that re-sizes the text container or the handwritten strokes,
wherein determining the placement is based on the user input.

9. A system for reflow of digitally entered handwritten characters into a device, the system comprising memory coupled to at least one processor, the at least one processor configured to:
receive handwritten strokes digitally entered into a text container presented using a device;
generate, using a first model, first groups of the handwritten strokes into text lines;
generate, using a second model, second groups of the handwritten strokes into words along the text lines;
determine, using a baseline estimation algorithm, a respective baseline for each of the text lines;
identify, for each respective baseline, a lowest x-coordinate of the handwritten strokes;
determine, for each of the words, a distance between a respective word on a respective baseline and a consecutive word on the respective baseline;
determine, based on a width of the text container, the respective baselines, and the distance, a placement of each of the words in the text container; and
cause presentation, using the device, of the words in the text container based on the placement.

10. The system of claim 9, wherein the first model is a line segmentation model, and wherein the second model is a word segmentation model.

11. The system of claim 9, wherein the placement of a left-most word along a respective baseline is based on a left-side border of the text container.

12. The system of claim 9, wherein the placement of a left-most word along a respective baseline is based on the lowest x-coordinate of the left-most word.

13. The system of claim 9, wherein the at least one processor is further configured to:
determine a second distance between a respective word along a respective baseline and a right-most border of the text container; and
determine that a length of a next word, following the respective word, and the distance between the respective word and the next word is less than the second distance,
wherein the next word is placed along the respective baseline following the respective word based on the length of the next word and the distance between the respective word and the next word being less than the second distance.

14. The system of claim 9, wherein the at least one processor is further configured to:
determine a second distance between a respective word along a respective baseline and a right-most border of the text container; and
determine that a length of a next word, following the respective word, and the distance between the respective word and the next word is greater than the second distance,
wherein the next word is placed along a next baseline below the respective baseline based on the length of the next word and the distance between the respective word and the next word being greater than the second distance.

15. A non-transitory computer-readable storage medium comprising instructions to cause at least one processor for reflow of digitally entered handwritten characters into a device, upon execution of the instructions by the at least one processor, to:
receive handwritten strokes digitally entered into a text container presented using a device;
generate, using a first model, first groups of the handwritten strokes into text lines;
generate, using a second model, second groups of the handwritten strokes into words along the text lines;
determine, using a baseline estimation algorithm, a respective baseline for each of the text lines;
identify, for each respective baseline, a lowest x-coordinate of the handwritten strokes;
determine, for each of the words, a distance between a respective word on a respective baseline and a consecutive word on the respective baseline;
determine, based on a width of the text container, the respective baselines, and the distance, a placement of each of the words in the text container; and
cause presentation, using the device, of the words in the text container based on the placement.

16. The non-transitory computer-readable storage medium of claim 15, wherein the first model is a line segmentation model, and wherein the second model is a word segmentation model.

17. The non-transitory computer-readable storage medium of claim 15, wherein the placement of a left-most word along a respective baseline is based on a left-side border of the text container.

18. The non-transitory computer-readable storage medium of claim 15, wherein the placement of a left-most word along a respective baseline is based on the lowest x-coordinate of the left-most word.

19. The non-transitory computer-readable storage medium of claim 15, wherein execution of the instructions further causes the at least one processor to:
determine a second distance between a respective word along a respective baseline and a right-most border of the text container; and
determine that a length of a next word, following the respective word, and the distance between the respective word and the next word is less than the second distance,
wherein the next word is placed along the respective baseline following the respective word based on the length of the next word and the distance between the respective word and the next word being less than the second distance.

20. The non-transitory computer-readable storage medium of claim 15, wherein execution of the instructions further causes the at least one processor to:
determine a second distance between a respective word along a respective baseline and a right-most border of the text container; and
determine that a length of a next word, following the respective word, and the distance between the respective word and the next word is greater than the second distance,
wherein the next word is placed along a next baseline below the respective baseline based on the length of the next word and the distance between the respective word and the next word being greater than the second distance.
